(19) United States
(12) Patent Application Publication
(10) Pub. No.: US 2026/0125046 A1
(43) Pub. Date: May 7, 2026

(54) HYBRID VEHICLE

(71) Applicant: SUBARU CORPORATION, Tokyo (JP)

(72) Inventor: Shuichi HONDA, Tokyo (JP)

(21) Appl. No.: 19/364,432

(22) Filed: Oct. 21, 2025

(30) Foreign Application Priority Data
Nov. 1, 2024 (JP) 2024-192942

(51) Int. Cl. B60W 20/40

(52) U.S. Cl. CPC B60W 20/40; B60W 2510/244; B60W 2530/209

(57) ABSTRACT

In a hybrid vehicle having a driving mode including a motor mode in which the engine is controlled to a stopped state and a hybrid mode in which the engine is controlled to an operating state, when the remaining amount of fuel falls below a lower limit value, a control system of the hybrid vehicle starts a drive-sustaining control that prohibits the hybrid mode and executes the motor mode. During execution of the drive-sustaining control, when an SOC of an energy storage device decreases to a drive-termination threshold, the control system sets a drive-disable flag and terminates the drive-sustaining control. Under a state where the drive-disable flag is set and the remaining amount of fuel exceeds the lower limit value by refueling, when a driver who drives the hybrid vehicle performs a start operation at the beginning of driving, the engine is started to start the hybrid mode.

### CROSS-REFERENCE TO RELATED APPLICATIONS

The present application claims priority from Japanese Patent Application No. 2024-192942 filed on November 1, 2024, the entire contents of which are hereby incorporated by reference.

### BACKGROUND

The disclosure relates to a hybrid vehicle. Hybrid vehicles equipped with an engine and a motor generator have been developed (see Japanese Unexamined Patent Application Publication (JP-A) Nos. 2008-201170, 2013-147057, and 2009-12593). An example of the driving mode for such a hybrid vehicle includes a motor mode in which the engine is controlled to a stopped state, and a hybrid mode in which the engine is controlled to an operating state.

However, under a state where the hybrid mode is being executed, when the remaining amount of fuel in a fuel tank falls below a lower limit value, the driving mode is switched from the hybrid mode to the motor mode. Additionally, the motor mode executed after fuel depletion is continued until driving of the motor generator becomes difficult, that is, until a state of charge (SOC) of a battery falls below a predetermined drive-termination threshold value. From the viewpoint of extending travel distance in the motor mode executed after fuel depletion, it is desirable to lower the drive-termination threshold value which is a termination condition of the motor mode.

### SUMMARY

An aspect of the disclosure provides a hybrid vehicle comprising an engine and a motor generator. The hybrid vehicle further comprises a fuel tank coupled to the engine via a fuel pipe, an energy storage device coupled to the motor generator via a power cable, and a control system configured to control the engine and the motor generator and comprising a processor and a memory communicably coupled to each other. A driving mode includes a motor mode in which the engine is controlled to a stopped state and a hybrid mode in which the engine is controlled to an operating state. When the remaining amount of fuel in the fuel tank falls below a lower limit value, the control system is configured to start a drive-sustaining control configured to prohibit the hybrid mode and execute the motor mode. During execution of the drive-sustaining control, when an SOC of the energy storage device decreases to a drive-termination threshold, the control system is configured to set a drive-disable flag and terminate the drive-sustaining control. Under a state where the drive-disable flag is set and the remaining amount of fuel exceeds the lower limit value by refueling, when a driver who drives the hybrid vehicle performs a start operation at the beginning of driving, the engine is started to start the hybrid mode.

### BRIEF DESCRIPTION OF THE DRAWINGS

FIG. 1 is a diagram illustrating a hybrid vehicle according to one embodiment of the disclosure.

FIG. 2 is a diagram illustrating an example of a power unit.

FIG. 3 is a diagram illustrating an example of a control system configured to control a power unit.

FIG. 4 is a diagram illustrating an example of basic structures of electronic controllers.

FIG. 5 is a map illustrating an example of an execution region for a driving mode.

FIG. 6 is a flowchart illustrating an example of an execution procedure for a drive-sustaining control.

FIG. 7 is a flowchart illustrating an example of an engine-start procedure after refueling.

FIG. 8 is a timing chart illustrating an example of an execution status of the drive-sustaining control and engine-start.

### DETAILED DESCRIPTION

Hereinafter, an embodiment of the disclosure will be described in detail with reference to drawings. In the following descriptions, the same or substantially same components and elements are denoted by the same reference signs and repetitive descriptions are omitted.

### Power Unit

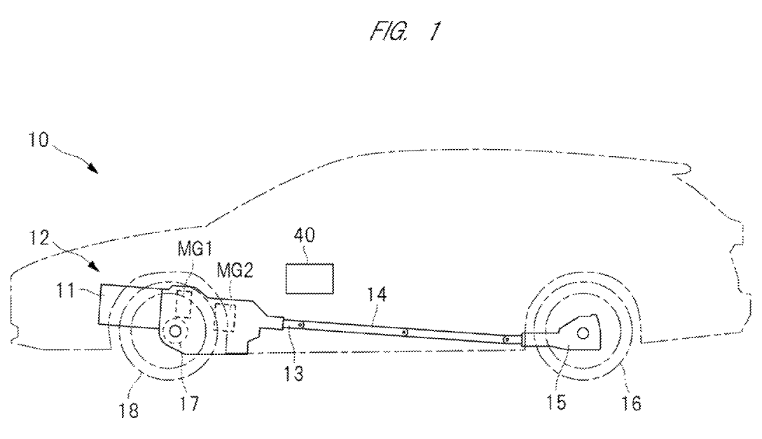

FIG. 1 is a diagram illustrating a hybrid vehicle 10 according to one embodiment of the disclosure. As illustrated in FIG. 1, the hybrid vehicle 10 comprises a power unit 12 having an engine 11 and motor generators MG1 and MG2. A rear wheel output shaft 13 of the power unit 12 is connected to one or more rear wheels 16 via a propeller shaft 14 and a rear differential mechanism 15. Additionally, the power unit 12 comprises a front differential mechanism 17. The front differential mechanism 17 is connected to one or more front wheels 18. The illustrated power unit 12 is a power unit for all-wheel drive, but the disclosure is not limited to this, and the power unit may be a unit for front-wheel drive or rear wheel-drive.

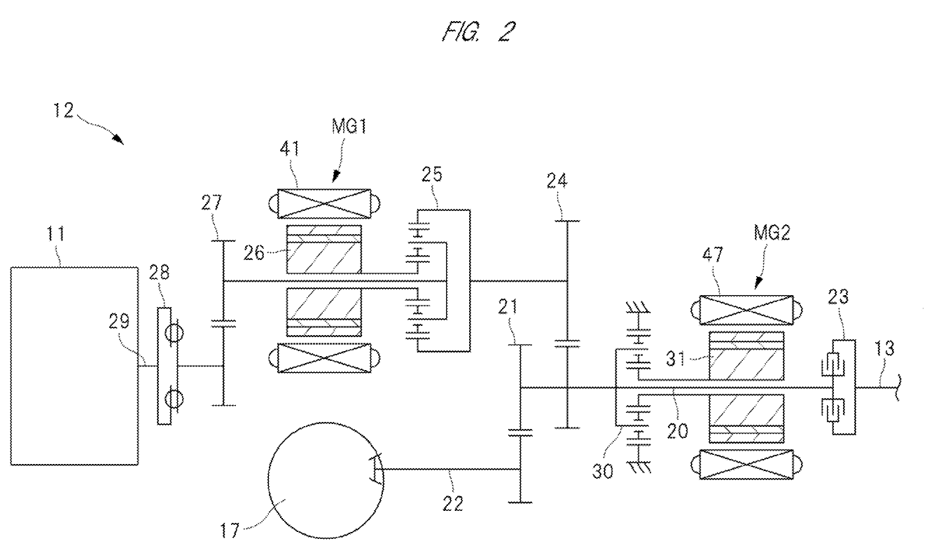

FIG. 2 is a diagram illustrating an example of the power unit 12. As illustrated in FIG. 2, the power unit 12 comprises a main output shaft 20 passing through a center of the motor generator MG2. The main output shaft 20 is connected to a front wheel output shaft 22 via a gear train 21, and is also connected to the rear wheel output shaft 13 via a transfer clutch 2. Additionally, the main output shaft 20 is connected to a power splitting mechanism 25 via a gear train 24. The power splitting mechanism 25 is connected to a rotor 26 of the motor generator MG1, and is also connected to a crankshaft 29 of the engine 11 via a gear train 27 and a damper mechanism 28. Additionally, the main output shaft 20 is connected to a rotor 31 of the motor generator MG2 via a planetary gear train 30. Further, the front wheel output shaft 22 is connected to the front differential mechanism 17.

### Motor Generator and Battery Pack

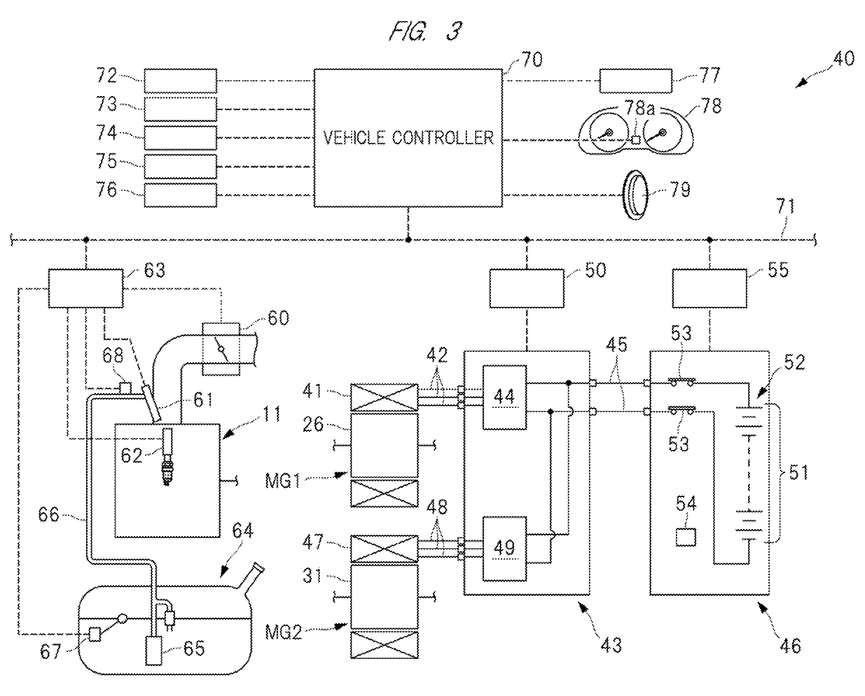

FIG. 3 is a diagram illustrating an example of a control system 40 configured to control the power unit 12. As illustrated in FIG. 3, a stator 41 of the motor generator MG1 is coupled to a switching circuit 44 of an inverter 43 via a power cable 42. Additionally, the switching circuit 44 is coupled to a battery pack 46 via a power cable 45. Similarly, a stator 47 of the motor generator MG2 is coupled to a switching circuit 49 of the inverter 43 via a power cable 48. Additionally, the switching circuit 49 is coupled to the battery pack 46 via the power cable 45. In this manner, the motor generator MG1 is coupled to the battery pack (energy storage device) 46 via the power cables 42 and 45, and the motor generator MG2 is coupled to the battery pack 46 via the power cables 48 and 45.

A motor controller 50 which is an electronic controller is coupled to the inverter 43 configured to execute an energization control of the motor generators MG1 and MG2. The motor controller 50 is configured to control the switching circuits 44 and 49 having multiple switching elements and the like so as to control the motor torque of the motor generators MG1 and MG2. Note that the motor torque of the motor generators MG1 and MG2 includes propulsion torque generated on an acceleration side by controlling the motor generators MG1 and MG2 to a propulsion state, and a regeneration torque generated on a deceleration side by controlling the motor generators MG1 and MG2 to a regeneration state.

The battery pack 46 comprises a battery module 52 having battery cells 51, a main relay 53 configured to control a coupled state of the battery module 52, and a battery sensor 54 configured to detect charge/discharge current, terminal voltage, and the like. A battery controller 55 which is an electronic controller is coupled to the battery pack 46. The battery controller 55 is configured to output a control signal to the main relay 53, and to switch the main relay 53 to an ON state or an OFF state. Additionally, the battery controller 55 is configured to calculate an SOC of the battery pack 46 based on the charge/discharge current, terminal voltage, and the like detected by the battery sensor 54. Note that the SOC of the battery pack 46 indicates a ratio of the remaining electrical charge stored in the battery pack 46, and is a ratio of the stored amount of charge to a fully charged capacity of the battery pack 46.

### Engine and Fuel Tank

As illustrated in FIG. 3, the engine 11 comprises a throttle valve 60 configured to adjust an intake air volume, an injector 61 configured to inject fuel, and an ignition device 62 configured to ignite an air-fuel mixture. In order to control an operating state of the engine 11, an engine controller 63 which is an electronic controller is coupled to the throttle valve 60, the injector 61, and the ignition device 62. Additionally, the hybrid vehicle 10 comprises a fuel tank 64 configured to store fuel such as gasoline. The fuel tank 64 houses a fuel pump 65, and the injector 61 is coupled to the fuel pump 65 via a fuel pipe 66. That is, the fuel tank 64 is coupled to the engine 11 via the fuel pipe 66. Additionally, a level sensor 67 configured to detect the remaining amount of fuel is mounted on the fuel tank 64, and a pressure sensor 68 configured to detect pressure of the fuel is mounted on the fuel pipe 66.

### Control System

As illustrated in FIG. 3, the hybrid vehicle 10 comprises the control system 40 having multiple electronic controllers. An example of the electronic controller of the control system 40 includes the motor controller 50, the battery controller 55, and the engine controller 63 described above. Additionally, an example of the electronic controller of the control system 40 includes a vehicle controller 70 configured to output control signals to each of the controllers 50, 55, and 63 described above. These controllers 50, 55, 63, and 70 are communicably coupled to one another via an in-vehicle network 71. The vehicle controller 70 is configured to set operating targets of the power unit 12 based on input information from the various controllers 50, 55, and 63 and various sensors described below. Additionally, the vehicle controller 70 is configured to generate control signals corresponding to the operating targets of the power unit 12, and to output these control signals to the motor controller 50, the engine controller 63, and the like.

An example of the sensor coupled to the vehicle controller 70 includes an accelerator sensor 72 configured to detect an operation status of an accelerator pedal, and a brake sensor 73 configured to detect an operation status of a brake pedal. Additionally, an example of the sensor coupled to the vehicle controller 70 includes a vehicle speed sensor 74 configured to detect vehicle speed or a traveling speed of the vehicle 10, and an engine rotation sensor 75 configured to detect rotation speed of the crankshaft 29. Further, an example of the sensor coupled to the vehicle controller 70 includes a motor rotation sensor 76 configured to detect rotation speed of the rotor 26 of the motor generator MG1, and a motor rotation sensor 77 configured to detect rotation speed of the rotor 31 of the motor generator MG2.

Additionally, a fuel level warning light 78a on a meter panel 78 and a start switch 79 operated when switching the power supply mode of the control system 40 are coupled to the vehicle controller 70. Note that an example of the power supply mode of the control system 40 includes an OFF mode in which functions of the control system 40 are stopped, and an ON mode in which the control system 40 is started to enable vehicle operation. For example, when a driver carrying a key (not shown) enters the vehicle and presses the start switch 79 while depressing the brake pedal, the power supply mode is switched from the OFF mode to the ON mode. In such a case, a start operation performed by the driver at the beginning of driving includes pressing the start switch 79 while depressing the brake pedal. When the power supply mode is in the OFF mode, the main relay 53 is controlled to an OFF state. Conversely, when the power supply mode is in the ON mode, the main relay 53 is controlled to an ON state.

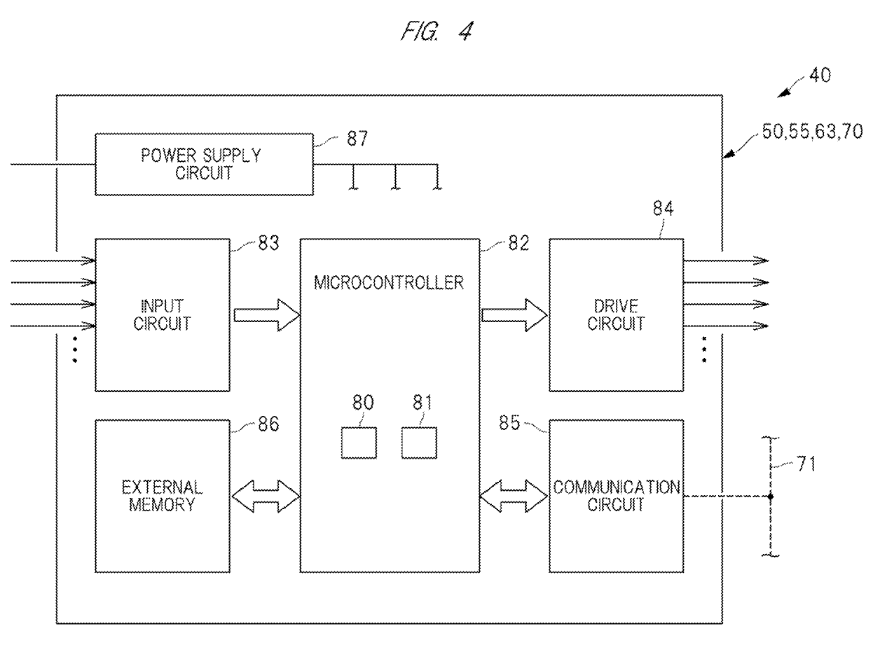

FIG. 4 is a diagram illustrating an example of basic structures of the electronic controllers 50, 55, 63, and 70. As illustrated in FIG. 4, the electronic controllers 50, 55, 63, and 70 each comprise a microcontroller 82 incorporating a processor 80, a main memory (memory) 81, and the like. A predetermined program is stored in the main memory 81, and the program is executed by the processor 80. The processor 80 and the main memory 81 are communicably coupled to each other. Note that multiple processors 80 may be incorporated into the microcontroller 82, and multiple main memories 81 may be incorporated into the microcontroller 82.

The electronic controllers 50, 55, 63, and 70 each comprise an input circuit 83, a drive circuit 84, a communication circuit 85, an external memory 86, and a power supply circuit 87. The input circuit 83 is configured to convert signals input from the various sensors into signals that can be input to the microcontroller 82. The drive circuit 84 is configured to generate drive signals for devices such as the inverter 43, the throttle valve 60, and the injector 61 described above based on the signals output from the microcontroller 82. The communication circuit 85 is configured to convert the signals output from the microcontroller 82 into communication signals directed to other electronic controllers and the like. Additionally, the communication circuit 85 is configured to convert the communication signals received from the other electronic controllers and the like into signals that can be input to the microcontroller 82. Further, the power supply circuit 87 is configured to supply a power voltage to the microcontroller 82, the input circuit 83, the drive circuit 84, the communication circuit 85, the external memory 86, and the like. Additionally, the program, various data and the like are stored in the external memory 86 having a non-volatile memory and the like.

### Driving Mode

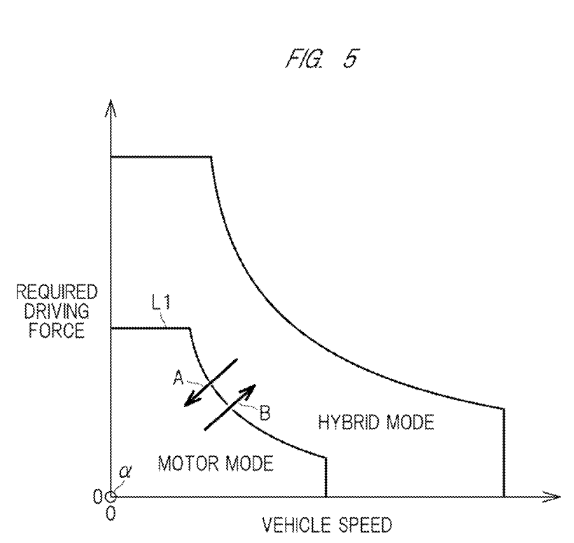

The hybrid vehicle 10 has two driving modes: a motor mode in which the engine 11 is controlled to a stopped state, and a hybrid mode in which the engine 11 is controlled to an operating state. FIG. 5 is a map illustrating an example of execution regions for these driving modes. As illustrated in FIG. 5, the map has a boundary line L1 that separates the execution regions for the motor mode and the hybrid mode. The required driving force illustrated in FIG. 5 is the driving force set based on the driver's accelerator operation. The required driving force is set to become larger as the accelerator pedal is depressed by the driver, that is, as an accelerator opening increases.

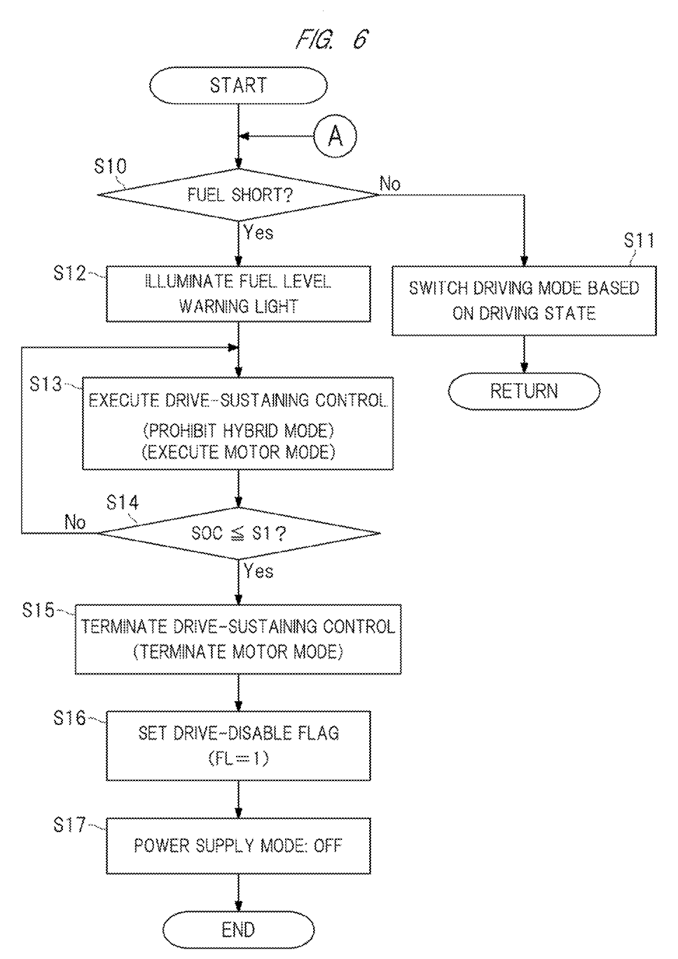

As indicated by arrow A in FIG. 5, during execution of the hybrid mode, when the required driving force falls below the boundary line L1 or when the vehicle speed decreases, the control system 40 switches the driving mode from the hybrid mode to the motor mode. Conversely, as indicated by arrow B in FIG. 6, during execution of the motor mode, when the required driving force exceeds the boundary line L1 or when the vehicle speed increases, the control system 40 switches the driving mode from the motor mode to the hybrid mode. When the driving mode is switched from the motor mode to the hybrid mode, a starting rotation of the engine 11 is performed by controlling the motor generator MG1 to the propulsion state.

As indicated by reference sign α in FIG. 5, the control system 40 is configured to select and execute the motor mode as the driving mode when the requested acceleration and vehicle speed are zero, that is, when the vehicle is stopped. Therefore, when the driver performs the start operation at the beginning of driving, the control system 40 starts the motor mode without starting the engine 11 since the hybrid vehicle 10 is in a vehicle state indicated by reference sign α. Note that, when the motor mode and the hybrid mode are executed, the control system 40 controls the motor generator MG1 to either the propulsion state or the regeneration state according to the driving state. Similarly, when the motor mode and the hybrid mode are executed, the control system 40 controls the motor generator MG2 to either the propulsion state or the regeneration state according to the driving state.

### Drive-Sustaining Control

A drive-sustaining control started when fuel shortage occurs will be now described. FIG. 6 is a flowchart illustrating an example of an execution procedure for the drive-sustaining control. Note that each step in the flowchart of FIG. 6 is executed by the processor 80 of the control system 40. Additionally, the flowchart illustrated in FIG. 6 is executed at predetermined intervals by the active control system 40.

As illustrated in FIG. 6, the control system 40 proceeds to step S10 and determines whether the fuel in the fuel tank 64 has depleted, that is, whether fuel shortage is occurring, based on a detection signal from the level sensor 67 provided in the fuel tank 64. That is, the control system 40 determines that fuel shortage is occurring when the remaining amount of fuel detected using the level sensor 67 falls below a predetermined lower limit value. Note that the control system 40 may determine whether fuel shortage is occurring also by using the pressure sensor 68 configured to detect the fuel pressure together with the level sensor 67 configured to detect liquid surface height. That is, the control system 40 may determine that fuel shortage is occurring when the remaining amount of fuel detected by the level sensor 67 falls below the lower limit value and the fuel pressure detected by the pressure sensor 68 falls below a predetermined value.

When the control system 40 determines in step S10 that no fuel shortage is occurring, the system proceeds to step S11 and switches the driving mode based on the driving state. That is, the control system 40 selects and executes the driving mode from among the motor mode and the hybrid mode based on the required driving force and vehicle speed. Conversely, when the control system 40 determines in step S10 that fuel shortage is occurring, the system proceeds to step S12 and illuminates the fuel level warning light 78a on the meter panel 78 to notify the driver that fuel shortage is occurring. Subsequently, since engine operation becomes impossible when fuel shortage is occurring, the control system 40 proceeds to step S13 and starts the drive-sustaining control that prohibits the hybrid mode and executes the motor mode.

When the drive-sustaining control is started when fuel shortage occurs, the control system 40 proceeds to step S14 and determines whether the SOC of the battery pack 46 is at or below a predetermined drive-termination threshold S1. When the control system 40 determines in step S14 that the SOC exceeds the drive-termination threshold S1, the system returns to step S13 and continues the drive-sustaining control, that is, the motor mode. Conversely, when the control system 40 determines in step S14 that the SOC is at or below the drive-termination threshold S1, the system proceeds to step S15 and terminates the drive-sustaining control, that is, the motor mode. The control system 40 then proceeds to step S16 and sets a drive-disable flag FL (FL=1), and proceeds to step S17 and switches the power supply mode to the OFF mode. Note that the situation in which the SOC is at or below the drive-termination threshold S1, that is, the situation in which the SOC decreases to the drive-termination threshold S1, occurs before the SOC reaches a discharge lower limit value SL which is a discharge tolerance value of the battery pack 46.

In this manner, the control system 40 starts the drive-sustaining control and forcibly executes the motor mode when fuel shortage occurs. This ensures that the minimum driving performance of the hybrid vehicle 10 is maintained even when the engine operation becomes impossible upon fuel depletion. As described above, the drive-sustaining control after fuel depletion continues until the SOC of battery pack 46 reaches the drive-termination threshold S1. Therefore, to ensure travel distance by the drive-sustaining control after fuel depletion, it is preferable to set the drive-termination threshold S1 close to the discharge lower limit value SL. Thus, as described below, in the hybrid vehicle 10 of the disclosure, the drive-termination threshold S1 is lowered to a value close to the discharge lower limit value SL which is a discharge limit of the battery pack 46. This is achieved by promptly starting the engine 11 after refueling to suppress discharge of the battery pack 46.

### Engine-Start After Refueling

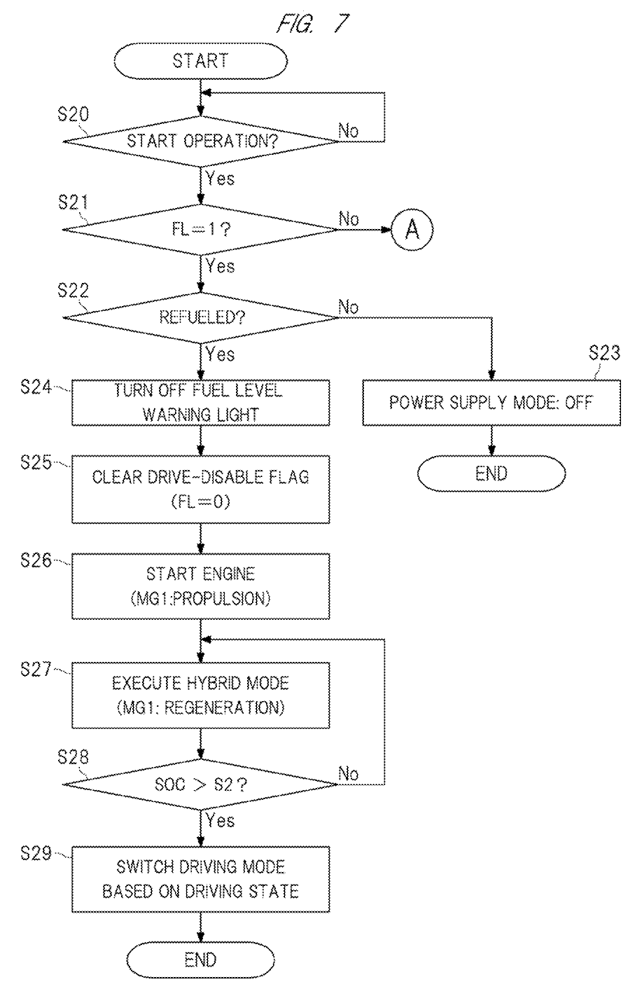

An engine-start procedure after refueling will now be described. FIG. 7 is a flowchart illustrating an example of the engine-start procedure after refueling. The flowchart in FIG. 7 is linked to the flowchart in FIG. 6 at the point marked with reference sign A. Note that each step described in the flowchart of FIG. 7 is a step executed by the processor 80 of the control system 40. Additionally, the flowchart in FIG. 7 is executed when the control system 40 is started.

As illustrated in FIG. 7, the control system 40 proceeds to step S20 and determines whether the driver is pressing the start switch 79 while depressing the brake pedal, that is, whether the driver is performing the start operation at the beginning of driving. When the control system 40 determines in step S20 that the driver is performing the start operation, the system proceeds to step S21 and determines whether the drive-disable flag FL is set. When the control system 40 determines in step S21 that the drive-disable flag FL is not set, that is, when fuel shortage is not occurring or the drive-sustaining control has not been terminated, the system proceeds to step S10 in FIG. 6. That is, when fuel shortage is not occurring, the system proceeds to step S11 where the driving mode is switched based on the driving state. When fuel shortage is occurring, the system proceeds to step S13 in which the drive-sustaining control continues.

As illustrated in FIG. 7, when the control system 40 determines in step S21 that the drive-disable flag FL is set, that is, when the drive-sustaining control has been terminated with a decrease in the SOC, the control system 40 proceeds to step S22 and determines whether refueling of the fuel tank 64 has already been performed. The control system 40 determines that refueling of the fuel tank 64 has been performed when the remaining amount of fuel detected by the level sensor 67 exceeds a remaining fuel threshold greater than the lower limit value. Additionally, the control system 40 may determine that refueling of the fuel tank 64 has been performed when the remaining amount of fuel detected by the level sensor 67 exceeds the lower limit value. Note that an example of situations in step S22 where it is determined that refueling has been performed includes a situation in which refueling has been performed by towing the hybrid vehicle 10 to a gas station and a situation in which refueling has been performed on the fuel tank 64 by a portable fuel canister brought to the site.

When the control system 40 determines in step S22 that refueling has not been performed, that is, when it is determined that fuel shortage persists even after termination of the drive-sustaining control, the control system 40 proceeds to step S23 and switches the power supply mode to the OFF mode, and exits the routine. That is, the situation determined in step S22 as not performing refueling is a situation in which it is impossible to drive the engine 11 and the motor generators MG1 and MG2. Therefore, the control system 40 proceeds to step S23 and switches the power supply mode to the OFF mode, and exits the routine.

Conversely, when the control system 40 determines in step S22 that refueling has been performed, the control system 40 proceeds to step S24 and turns off the fuel level warning light 78a, and proceeds to step S25 and clears the drive-disable flag FL (FL=0). Additionally, the control system 40 proceeds to step S26 and controls the motor generator MG1 to the propulsion state, and causes the motor generator MG1 to perform the starting rotation of the engine 11. When the engine 11 is started in step S26, the control system 40 proceeds to step S27, controls the motor generator MG1 to the regeneration state, and executes the hybrid mode in which the engine 11 causes the motor generator MG1 to perform a regeneration drive.

Next, the control system 40 proceeds to step S28 and determines whether the SOC of the battery pack 46 exceeds a predetermined charging termination threshold S2. When the control system 40 determines in step S28 that the SOC is at or falls below the charging termination threshold S2, the system returns to step S27 and continues the regeneration drive of the motor generator MG1 by the engine 11. Conversely, when the control system 40 determines in step S28 that the SOC exceeds the charging termination threshold S2, the system proceeds to step S29 and switches the driving mode based on the driving state.

As described above, after the control system 40 starts the drive-sustaining control when fuel shortage occurs and then the SOC of the battery pack 46 decreases to the drive-termination threshold S1, the system sets the drive-disable flag FL and terminates the drive-sustaining control. Thereafter, under a state where the drive-disable flag FL is set and the remaining amount of fuel exceeds the lower limit value by refueling, when the driver performs the start operation at the beginning of driving, the control system 40 starts the engine 11 in the hybrid mode.

In this manner, after fuel depletion occurs, the SOC decreases, the drive-sustaining control has been terminated, and the fuel tank 64 is refueled, when the driver performs the start operation, the control system 40 starts the engine 11 to start the hybrid mode. That is, as indicated by reference sign α in FIG. 5, under a situation where the driver performs the start operation at the beginning of driving, the motor mode would fundamentally start without starting the engine 11, whereas for the control system 40 of the disclosure, the hybrid mode is immediately started when the driver performs the start operation. Thus, the motor mode is not executed again after the termination of the drive-sustaining control, making it possible to minimize discharge of the battery pack 46. Therefore, even when the drive-termination threshold S1 is lowered to a value close to the discharge lower limit value SL, the SOC of the battery pack 46 can be prevented from falling below the discharge lower limit value SL. That is, since the drive-termination threshold S1 can be lowered while suppressing overdischarge of the battery pack 46, the travel distance achievable by the drive-sustaining control can be extended.

### Timing Chart

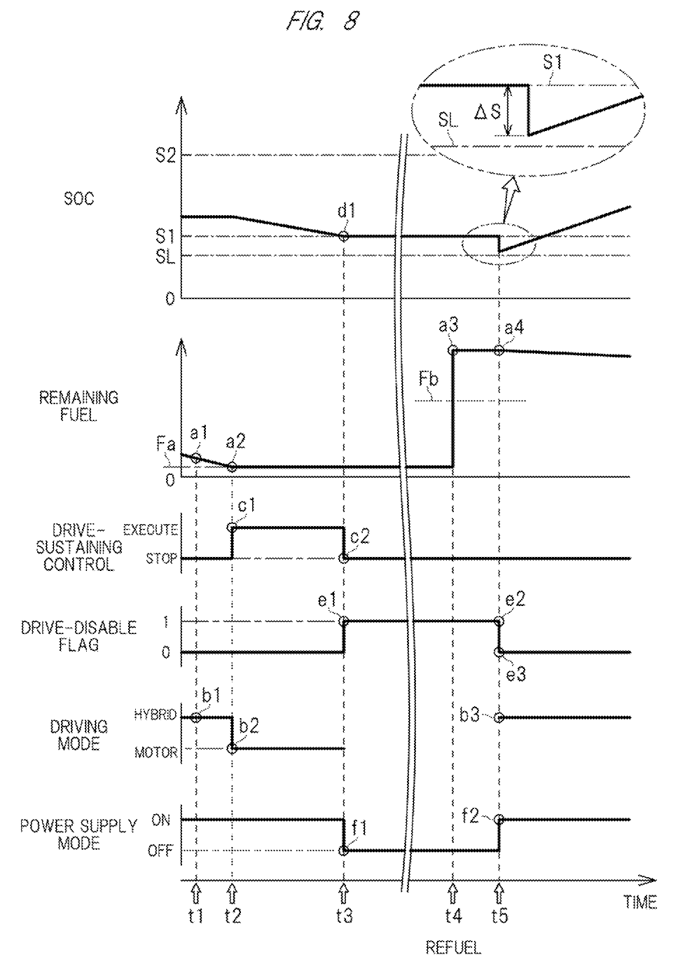

The drive-sustaining control when fuel shortage occurs and the engine-start after refueling will now be described. FIG. 8 is a timing chart illustrating an example of an execution status of the drive-sustaining control and the engine-start.

As illustrated in FIG. 8, at time t1, the remaining amount of fuel exceeds a lower limit value Fa (reference sign a1), and the hybrid mode is being executed as the driving mode (reference sign b1). At time t2, since the remaining amount of fuel falls below the lower limit value Fa (reference sign a2), the drive-sustaining control in which the hybrid mode is prohibited and the motor mode is executed is started (reference signs b2, c1). Subsequently, at time t3, since the SOC of the battery pack 46 has decreased to the drive-termination threshold S1 (reference sign d1), the drive-sustaining control is stopped (reference sign c2), the drive-disable flag FL is set (reference sign e1), and the power supply mode is switched to the OFF mode (reference sign f1).

Thereafter, at time t4, when refueling of the fuel tank 64 is performed, the remaining amount of fuel exceeds a remaining fuel threshold Fb (reference sign a3). Subsequently, at time t5, the driver performs the start operation at the beginning of driving such that the power supply mode is switched to the ON mode (reference sign f2), and the engine 11 is started to start the hybrid mode (reference sign b3). That is, under a state where the drive-disable flag FL is set (reference sign e2) and the remaining amount of fuel exceeds the remaining fuel threshold Fb by refueling (reference sign a4), when the driver performs the start operation at the beginning of driving, the engine 11 is started to start the hybrid mode (reference sign b3). Additionally, under a state where the drive-disable flag FL is set (reference sign e2) and the remaining amount of fuel exceeds the remaining fuel threshold Fb (reference sign a4), when the driver performs the start operation at the beginning of driving, the drive-disable flag FL is subsequently cleared (reference sign e3).

As described above, after fuel depletion occurs, the SOC decreases, the drive-sustaining control has been terminated, and the fuel tank 64 is refueled, when the driver performs the start operation, the control system 40 starts the engine 11 to start the hybrid mode. Thus, the motor mode is not executed again after the termination of the drive-sustaining control, making it possible to minimize discharge of the battery pack 46. Therefore, as illustrated in the enlarged portion of FIG. 8, a difference between the discharge lower limit value SL and the drive-termination threshold S1 can be set to a value close to a power consumption ΔS during engine-start. That is, since the drive-termination threshold S1 can be lowered, the travel distance achievable by the drive-sustaining control can be extended. Note that the power consumption ΔS at the time of engine-start refers to the power consumed by the motor generator MG1 for cranking or performing the starting rotation of the engine 11.

### Modification Example

This disclosure is not limited to the above embodiments and may be modified in various ways within the range not departing from the gist of the disclosure. The illustrated power unit 12 comprises two motor generators MG1 and MG2, but the disclosure is not limited to this, and the power unit may comprise a single motor generator. Additionally, the illustrated hybrid vehicle 10 is a series parallel hybrid vehicle, but the disclosure is not limited to this, and the hybrid vehicle may be a series hybrid vehicle.

Additionally, in the flowchart illustrated in FIG. 6, the drive-disable flag FL is set in step S16 after the drive-sustaining control is terminated in step S15, but the disclosure is not limited to this, and the drive-sustaining control may be terminated after the drive-disable flag FL is set. The above description exemplifies the start operation performed by the driver at the beginning of driving as pressing the start switch 79 while depressing the brake pedal, but the disclosure is not limited to this, and other operations are possible. The above description exemplifies gasoline as the fuel, but the disclosure is not limited to this, and other types of fuel such as diesel fuel and hydrogen may also be used.

According to the disclosure, the drive-termination threshold can be lowered, and the travel distance achievable by the drive-sustaining control can be extended.

1. A hybrid vehicle comprising an engine and a motor generator, the hybrid vehicle further comprising:
a fuel tank coupled to the engine via a fuel pipe;
an energy storage device coupled to the motor generator via a power cable; and
a control system comprising a processor and a memory communicably coupled to each other, and configured to control the engine and the motor generator,
wherein a driving mode includes a motor mode in which the engine is controlled to a stopped state and a hybrid mode in which the engine is controlled to an operating state,
wherein, when the remaining amount of fuel in the fuel tank falls below a lower limit value, the control system is configured to start a drive-sustaining control configured to prohibit the hybrid mode and execute the motor mode,
wherein, during execution of the drive-sustaining control, when an SOC of the energy storage device decreases to a drive-termination threshold, the control system is configured to set a drive-disable flag and terminate the drive-sustaining control, and
wherein, under a state where the drive-disable flag is set and the remaining amount of fuel exceeds the lower limit value by refueling, when a driver who drives the hybrid vehicle performs a start operation at the beginning of driving, the engine is started to start the hybrid mode.

2. The hybrid vehicle according to claim 1,
wherein the control system is configured to cause the motor generator to perform a starting rotation of the engine.

3. The hybrid vehicle according to claim 1,
wherein, under a state where the drive-disable flag is not set, when the driver performs the start operation at the beginning of driving, the control system is configured to start the motor mode without starting the engine.

4. The hybrid vehicle according to claim 1,
wherein, under a state where the drive-disable flag is set and the remaining amount of fuel exceeds the lower limit value by refueling, when the driver performs the start operation at the beginning of driving, the control system is configured to start the engine to start the hybrid mode and cause the motor generator to perform a regeneration drive by the engine.

5. The hybrid vehicle according to claim 1,
wherein, under a state where the drive-disable flag is set and the remaining amount of fuel exceeds a remaining fuel threshold by refueling, when the driver performs the start operation at the beginning of driving, the control system is configured to start the engine to start the hybrid mode,
wherein the remaining fuel threshold is greater than the lower limit value.
